(19) United States
(12) Patent Application Publication
(10) Pub. No.: US 2002/0154102 A1
(43) Pub. Date: Oct. 24, 2002

(54) System and method for a programmable color rich display controller

(76) Inventor: James R. Huston, Boulder Creek, CA (US)

Correspondence Address: SILICON VALLEY INTELLECTUAL PROPERTY GROUP, P.O. BOX 721120, SAN JOSE, CA, 95172-1120, US

(21) Appl. No.: 09/792,291

(22) Filed: Feb. 21, 2001

(51) Int. Cl. G09G 5/00

(52) U.S. Cl. 345/204

(57) ABSTRACT

A programmable display controller is provided including an input for receiving data from a data source. Further included is a processor coupled to the input. The processor is adapted for being programmed to process the received data in accordance with user-specified instructions. Coupled to the processor is an output for sending the processed data to at least one display module for driving the display module(s) in accordance with the user-specified instructions. Such driving includes the control of low-level functions associated with the display.

### FIELD OF THE INVENTION

The present invention relates to display controllers, and more particularly to display controllers capable of driving microdisplays.

### BACKGROUND OF THE INVENTION

A continuing objective in the field of electronics is the miniaturization of electronic devices. Most electronic devices include an electronic display. As a result, the miniaturization of electronic displays is critical to the production of a wide variety of compact electronic devices. For example, as electronic devices such as personal digital assistants, cell phones, digital still cameras, DVD players and internet appliances become ever smaller and more portable, the demands on the electronic displays for these products must meet difficult and seemingly contradictory requirements. On the one hand, the displays must provide increasing amounts of high quality visual information, sometimes approaching that of a desktop monitor. Yet these displays must still be very compact and lightweight, consume little power, and be produced at low cost. Until recently, displays were not able to meet all of these requirements.

The aforementioned electronic displays all require display controllers. Traditionally, such display controllers are responsible for the control of many low-level functions associated with driving a display. By way of example, such low-level functions may include frame rate control, refreshing, field sequencing, DC balance management, illumination, and frame buffer control. It should be noted that such low-level functions are not limited to the above examples, and may include any function performed at the hardware-level. More information regarding some of the above examples of low-level functions will now be set forth.

Frame Rates

A complete raster scan of the LCD screen is referred to as a frame. The number of complete frames presented from the display driver to the screen per second is called the frame rate. It is desirable to maintain the frame rate at a low level, because high frame rates require high clock frequencies, adding to the expense and adding to the drain on the power source. For portable equipment, generally powered by battery, low battery drain is an important design parameter. On the other hand, if the frame rate is too low, visible flicker becomes apparent to the human eye. Experience shows that an appropriate frame rate is approximately 50 to 60 Hz.

Due to their nature of operation, LCD's are prone to screen flicker when viewed under certain man-made lighting sources, such as some fluorescent light fixtures. Screen flicker is observed as “ripples” which “flow” through the display image at a frequency equal to the difference between the LCD frame rate and the ambient light modulation frequency (60 Hz for example). This screen flicker reduces image quality and can promote eye strain. LCD frame rate adjustment and synchronization may be done to eliminate the screen flicker problem.

Refreshes

Refreshes are related to frame rates in that a refresh is the operation that is carried out during every periodic interval determined by the frame rate.

Field Sequencing

A color image may be produced in a “spatial” arrangements by the use of a plurality color elements, i.e., color pixels. Each of these color pixels contains three subpixels including red, green, and blue (RGB) subpixels. The subpixels are arranged to display in almost identical spatial point on the screen that the eye cannot resolved these three individual elements. A viewer would then perceive each pixel as a single color element. By arranging the relative intensity of the individual color subpixels, the combination of RGB can generate a great variety of colors. Each color image is decomposed into red, green and blue color field of varying intensity.

Alternatively, a single pixel may be used to present R, G and B colors separated by a time interval and presented rapidly enough that the human visual system fuses the individual color fields into a full color image. This is generally referred to as field sequential color. The relative intensity of individual pixels can be controlled in either an aalog or digital fashion.

Frame Buffer

Typically, a graphics acceleration system renders a modeled scene by generating pixel data for storage in a frame buffer memory. In lower-end applications in which graphics acceleration system is not present, host computer system may generate the pixel data itself and write the pixel data into the frame buffer directly. The contents of the frame buffer memory are continually read by a random access memory/digital-to-analog converter (“RAMDAC”) module which typically contains color or gamma correction lookup tables and drives a display monitor. Note that in all-digital systems, a memory to display transfer is effectuated without use of a RAMDAC (simple Direct Memory Access, or “DMA”). Multiple transfers may be necessary to generate multiple levels of pixel intensities.

Also common is to use a technique known as double buffering. In double buffering, two frame buffers and are provided instead of a single frame buffer. In this manner, a host computer system or graphics acceleration system can write pixel data into one frame buffer (the “non-viewable” or “back” buffer) while the RAMDAC or DMA module transfer display pixel data previously written into the other frame buffer (the “viewable” or “front” buffer). The effect of this technique is to reduce tearing and other unwanted visual artifacts that are introduced into an image when the contents of a frame buffer are changed while the contents of the same frame buffer are being displayed. In systems that use two buffers, it is known to use a frame buffer controller to coordinate which buffer will be viewable and which will be non-viewable at any given moment. Specifically, a swap controller within frame buffer controller indicates when it is safe to stop displaying the contents of one frame buffer and to start displaying the contents of the other frame buffer. Typically, swap controller will indicate that it is safe to swap frame buffers at the moment when (1) the graphics pipeline has finished rendering pixel data into the non-viewable buffer, and (2) the current raster position of the display is not within the window of interest.

Standard display controllers are available in the marketplace but such standard controllers are costly and have limited applicability and fixed displays corresponding to their application. More importantly, such controllers only allow the control of high-level operations associated more with the content being displayed.

In other words, a major drawback of prior art display controllers is that the controlling functions for a particular type of display are permanently built into the hardware that controls that type of display. Thus, the display controller for that type of display will not work with another type of display. Even those display controllers that include programmable registers are not immune from this drawback, as the registers only allow setting of certain parameters for the particular type of display associated with the controller.

Prior art systems have been shaped by the need for increasing throughput to accommodate higher resolution displays, without concern for new drive methodologies. This has limited innovation with respect to power consumption, color generation, etc.

Notwithstanding the existing available controllers, there is a need for a universal programmable controller that may be manufactured as a standard unit, programmed at a low-level to be applicable in a universe of related hardware, and sellable at low cost in large quantities.

### SUMMARY OF THE INVENTION

A programmable display controller is provided including an input for receiving image data from a data source such as, for example, a host processor, gaming console, digital camera, etc. Image data can include video, 2-D and 3-D computer graphics, game console output, digital camera data, etc. Image data can also include data presented in a stereoscopic format. Further included is a processor coupled to the input and preferably embedded in the display controller. The processor is adapted for being programmed to process the received data in accordance with user-specified instructions. Coupled to the processor is an output for sending the processed data to at least one display module (i.e., graphical display such as a CRT, LCD screen, OLED display, microdisplay, plasma display, Ferroelectric Device (FED) display, etc.) for driving the display module(s) in accordance with the user-specified instructions. Such driving includes the control of low-level functions associated with the display.

By way of example, such low-level functions may include frame rate control, refreshing, field sequencing, DC balance management, illumination, external signaling, and/or frame buffer control. It should be noted that such low-level functions are not limited to the above examples, and may include any function performed at the controller level.

As an option, two or more display modules may be driven by the display controller. Further, the display controller may also include a Dithering And Planarization Processing Engine and Router (DAPPER).

In another embodiment of the present invention, the processor of the display controller may be programmed utilizing electronically erasable programmable read only memory (EEPROM), or an external processor. Moreover, the processor of the display controller is programmed utilizing an instruction set as opposed to setting parameters in registers.

In use, the processor of the display controller may function as a direct memory access (DMA) controller. To this end, the processor of the display controller may transfer data from a frame buffer to a backplane associated with the display module(s). Optionally, the memory accessed may include a synchronous dynamic random access memory (SDRAM).

Associated with the display controller is a method for controlling operation of a display. In use, the processor of the display controller is initially programmed. Thereafter, at least one display module is driven with the display controller in accordance with the programming. The processor of the display controller is thus capable of being programmed to drive the display module(s) in a plurality of drive modes. Such drive modes may be dictated by various combinations of instructions selected from a predetermined instruction set.

In another embodiment, a computer program product containing software may be provided. The software, when loaded into the processor of a display controller, specifies the operation of the display controller to drive one or more display modules, where the driving includes the control of low-level functions associated with the display(s).

### BRIEF DESCRIPTION OF THE DRAWINGS

FIG. 1 illustrates the controller of the present invention in one exemplary environment;

FIG. 2 illustrates a schematic diagram showing the controller, and an associated interface between the controller and the remaining components of FIG. 1 in greater detail;

FIGS. 3-3B illustrate an exemplary pin out associated with the controller of FIGS. 1 and 2;

FIGS. 4-10 illustrate exemplary pin outs for the various components coupled to the controller including the system interface, synchronous dynamic random access memory (SDRAM), analog controller, serial interface, tap control, test, and PLL, respectively;

FIG. 11 illustrates an exemplary address map for a color rich application specific integrated circuit (CRASIC) of the controller of the present invention;

FIGS. 12-22 illustrate register maps associated with the various components of the present invention;

FIG. 23 illustrates how each byte of image data is processed through palettes of the controller, adjusted by a dithering bias grid module, and separated into individual bit planes;

FIG. 24 illustrates a pair of first-in-first-out (FIFO) registers associated with the display controller of the present invention;

FIG. 25 is a chart illustrating the various start conditions associated with the instructions of the color rich instruction set processor (CRISP);

FIG. 26 illustrates a chart including CRISP branch conditions;

FIGS. 27-57 illustrate the various instructions that may be executed by the CRISP, in accordance with one embodiment of the present invention; and

FIG. 58 illustrates an exemplary architecture associated with the display modules shown in FIGS. 1 and 2.

### DESCRIPTION OF THE PREFERRED EMBODIMENTS

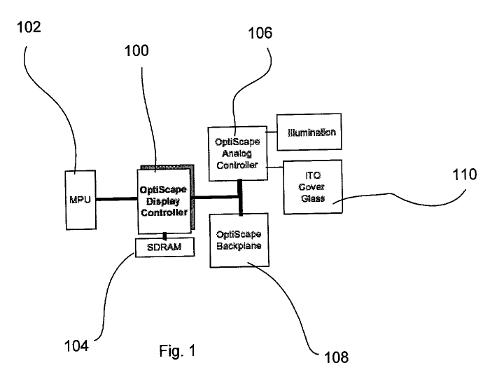

FIG. 1 illustrates a controller 100 of the present invention in one exemplary environment. As shown, the display controller 100 includes a processor 102. Ideally, the processor is embedded into the display controller itself.

Because the processor is programmable, the display controller can manage the timing and transfer of data in ways that existing controllers cannot. For example, the display controller can respond to devices which have different display characteristics and therefore require different methods of control. In this case, a specific description of control requirements can be stored in the display device itself to be retrieved by the display controller when connected to the display device. The display controller can then specifically be reprogrammed to accommodate the characteristics of the display, even when such characteristics were unknown at the time the display controller was implemented.

The processor also allows the display controller to control the flow of data from the frame buffer, including selecting data from different portions of the frame buffer. For example, the present invention enables the display controller to place composite images over the image being displayed, such as a company logo superimposed over a constantly changing video stream. Another example is Picture in Picture (PIP).

Further, the processor allows the display controller to control auxiliary external signals programmatically (i.e., how they are done, when they are done, etc. can be controlled in many different ways), such as using an auxiliary signal to control a multiplexer for selecting which of two or more video input streams to display. For example, two video streams could represent left and right points of view for stereoscopic imaging. Left and right streams could be alternately channeled to separate frame buffers for presentation to two displays (left and right) to reconstruct a stereoscopic image in a binocular viewing system.

The processor of the display controller is thus capable of being programmed to drive the display module(s) in a plurality of drive modes. Such drive modes may be dictated by various combinations of instructions selected from a predetermined instruction set. Illustrative drive modes include a balanced binary color drive mode, a digitally controlled waveform drive mode, and an analog controlled waveform drive mode, described in U.S. application Ser. No. ______ entitled SYSTEM AND METHOD FOR COLOR AND GRAYSCALE DRIVE METHODS FOR GRAPHICAL DISPLAYS UTILIZING ANALOG CONTROLLED WAVEFORMS filed on Dec. 14, 2000 and which is incorporated herein by reference in its entirety.

With continued reference to FIG. 1, also coupled to the controller 100 is a synchronous dynamic random access memory (SDRAM) 104. Further included are an analog controller 106 and a backplane integrated circuit 108 of a display module which is also coupled to the controller 100. In one embodiment, an INVISO OPTISCAPE display module, or any other microdisplay may be utilized. In other embodiments, the display module can be a Liquid Crystal Display (LCD), Cathode Ray Tube (CRT), Organic Light-Emitting Diode (OLED) display etc. The analog controller 106 is further coupled to a cover glass for controlling the operation thereof.

In operation, the controller 100 serves as the external frame buffer controller and system interface for the display module. The controller 100 receives image data from the processor 102, reformats the data, and transmits the data to the backplane integrated circuit 108 of the display module. The backplane integrated circuit 108 maps the data onto an 800×600 pixel (SVGA) liquid crystal silicon display. It should be noted that any other size device may also be employed in the context of the present invention. Further, controller 100 controls the transfer of data from the frame buffer to the display module, providing an enhanced color rich image that is illuminated with the help of the analog controller 106, and light emitting diodes (LEDs).

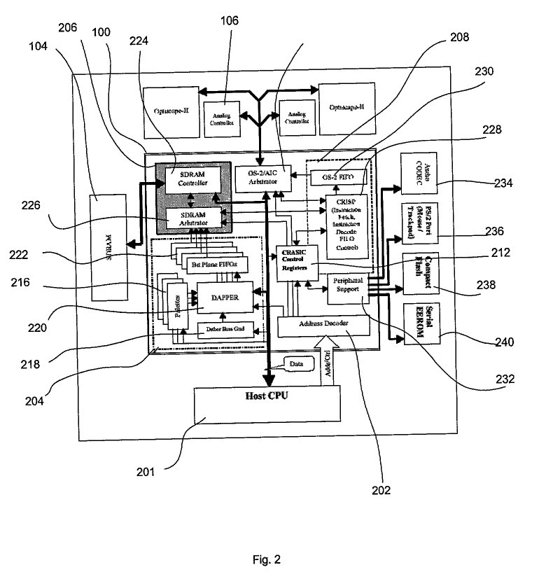

FIG. 2 illustrates a schematic diagram illustrating the controller 100, and an interface between the controller 100 and the remaining components of FIG. 1 in greater detail. As shown in FIG. 2, the controller 100 receives the information from the host 201 under the control of an address decoder 202. Such received information is fed to a first module 204, a second module 206, a third module 208, an arbitrator 210, and control registers 212.

With continuing reference to FIG. 2, the first module 204 is shown to include a plurality of palettes 216, a dither bias grid 218, and a dithering and planarization processing engine and router (DAPPER) 220 each of which receives the information from the host 201. The manner in which the palettes 216, dither bias grid 218, and DAPPER 220 process the information received from the host 201 will be set forth in greater detail hereinafter. Once processed, the information is sent from the DAPPER 220 to a plurality of bit plane first-in-first-out registers (FIFOs) 222.

The second module 206 includes a SDRAM controller 224 and a SDRAM arbitrator 226 which receive the information from the host 201, and further receives the processed information from the bit plane FIFOs 222. The operation of the various components of the second module 206 will be set forth in greater detail later.

With respect to the third module 208, a color rich instruction set processor (CRISP) 228 is provided which receives the information from the host 201, processes it in a manner which will soon be set forth, and feeds the processed information to the arbitrator 210 by way of a OS-2 FIFO 230.

Further included is a peripheral support module 232 which feeds a peripheral graphics logic unit (GLU) including a plurality of peripheral components such as an audio component 234, a PS/2 component 236, a compact flash component 238, and a serial electronically erasable read-only memory (EEPROM) component 240.

Table 1 illustrates optional specifications, i.e. features, interface, timing, etc., with which the controller 100 may be equipped.

TABLE 1

Features
66 MHZ synchronous interface to host processor.
3.3 V I/Os
2.5 V Core power
Implemented in .25u cmos
304 pin BGA package
Awake/Active/Dormant and Sleep power saving modes
Host MPU to OptiScape MicroDisplay, Analog Controller and
SDRAm
Pin Description
SDRAM Interface
13 - address lines
32 - data lines
SDRAM's Chip select & Clock enable permanently tied
to ground & power respectively.
9 - control lines for the SDRAM control (rasn, casn,
wrn, clk, dqmo0, 3, cke)
54 pins
Processor interface
control (Reset, interrupt, oen, wen, 2 chip selects,
ready)
address lines
data lines
1 - clock input
64 pins
Analog Controller Interface
data lines
address lines
2 chips select for Analog Controller and OPTISCAPE
sets Interrupt lines for the OPTISCAPE set
2 clocks for the Analog Controller and OPTISCAPE
sets
ready and rdcen lines for the OPTI set
2 - PORstn from 2 Analog Controllers (may be reduced
to 1)
common reset to 2 sets of Analog Controller and
OPTISCAPEs
common write enable signal to all
56 pins
Misc.
2 - Touch pad clock and data
2 - power (FET) enable for the OPTI/ANALOG
2 - Serial Bus clock and data (bus master)
2 - general-purpose i/os.
1 - PLL clock input
9 pins
Optional flash interface
If current flash interface is considered, 34 pins. (5 pins
may be eliminated, subject to system level verification.)

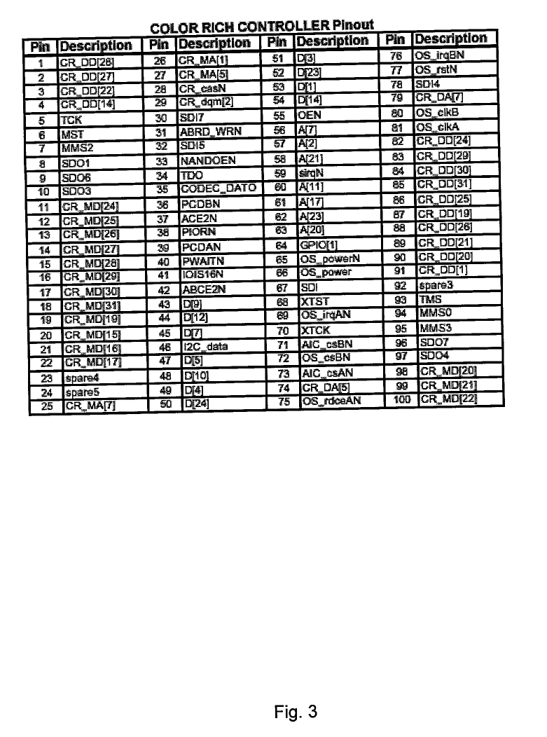

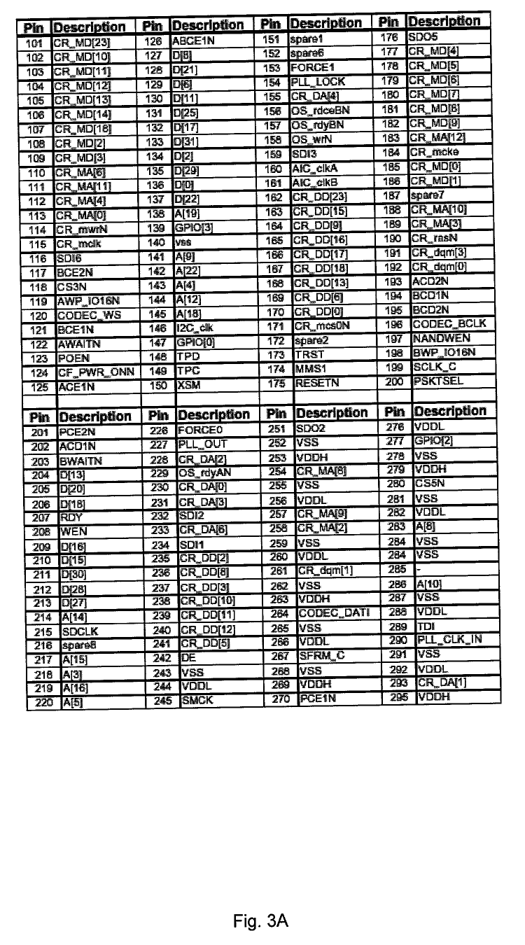

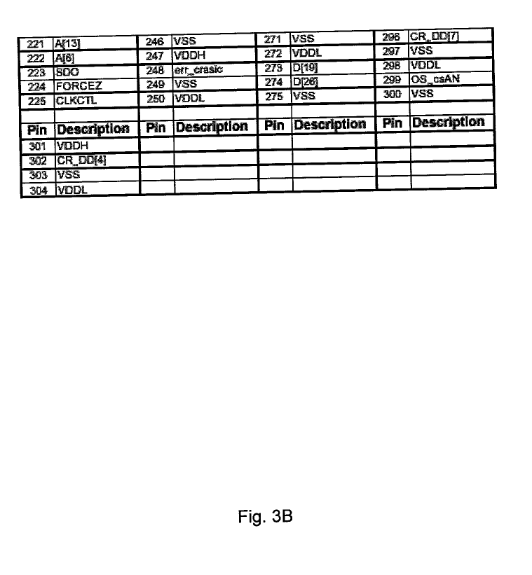

FIGS. 3-3B illustrate an exemplary pin out associated with the controller 100 of FIGS. 1 and 2. Table 2 illustrates a legend to be used in interpreting the various symbols utilized in the present description and accompanying figures.

TABLE 2

* - indicates these 55 pins do not come out of the
MultiChip Module (when the Color Rich Display
Controller is packaged in an MCM with SDRAM and
Serial-EEPPROM.)
% - indicates these will not be available in a
[proposed] smaller package.
$ - indicates these 5 pins may or may not be
implemented in the final design.
@ - indicates test pins. These pins are used for
test purposes. May not have to come out of MCM.

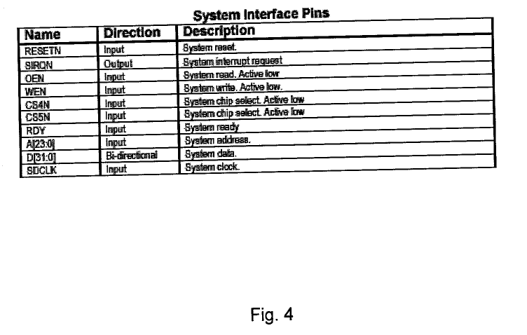

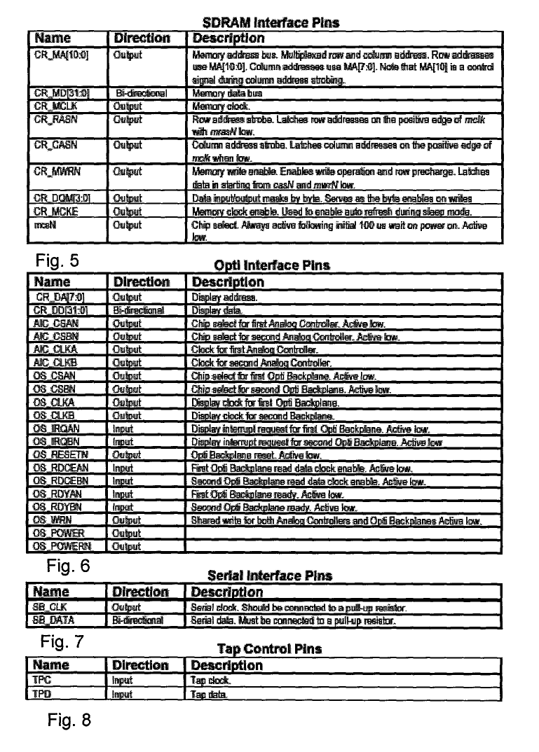

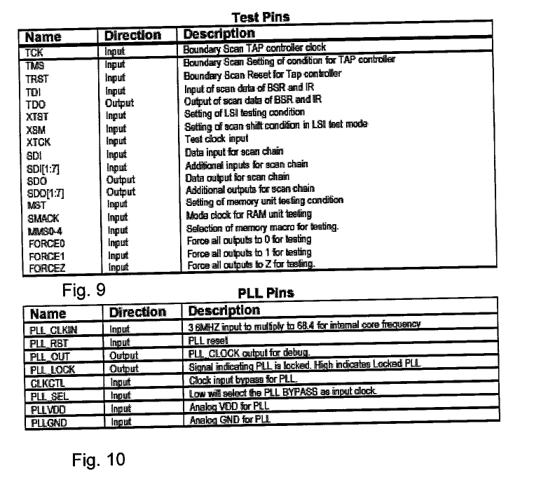

FIGS. 4-10 illustrate exemplary pin outs for the various components coupled to the controller 100 including the system interface, SDRAM, analog controller, serial interface, tap control, test, and PLL, respectively.

Further descriptions of the operation of the various components of the present invention will now be set forth. It should be noted that the controller 100 may be capable of supporting two display modules. In use, the SDRAM controller 224 of the controller 100 is capable of providing access to the SDRAM 104 for the DAPPER 220, CRISP 228, and the host 201. The SDRAM controller 224 also takes care of refreshing the SDRAM 104.

The DAPPER 220 converts incoming 8-bit/pixel data from the host 201 into the 24-bit color space, then dithers down to 9, 12, or 15 “Bit Planes”. The dithering process attempts to preserve general 24-bit color depth by sacrificing absolute spatial resolution, e.g., adjusting the color of adjacent bits to give an overall illusion that color has been preserved. For more information regarding dithering, reference may be made to U.S. application Ser. No. ______ entitled SYSTEM AND METHOD FOR SUPERFRAME DITHERING IN A LIQUID CRYSTAL DISPLAY filed on ______, which is incorporated herein by reference in its entirety.

The CRISP 228 may be a highly programmable processor that manages timing and data transfers to the display modules to produce images. The CRISP 228 may, in its full implementation, also take care of tasks such as cursor management, LC temperature compensation, and stereo audio. The peripheral graphics logic unit (GLU) may include a PS/2 port for supporting a touchpad, supplemental logic for compact flash slots, and serial device bus master.

The external interface for the controller 100 provides the means for a host processor to access the entire contents of the SDRAM 224, display registers and memory, and analog controller(s) 106 registers. These devices, along with the controller 100 own registers, are arranged into a unified memory map. The microprocessor 102 may be interfaced using the full 22-bit address bus, allowing direct access to the entire map. For applications where fewer address lines are desirable, just 13 address lines may be used. In one embodiment, device registers are fully addressable and SDRAM 104 is accessed indirectly through the use of an auto-increment pointer register.

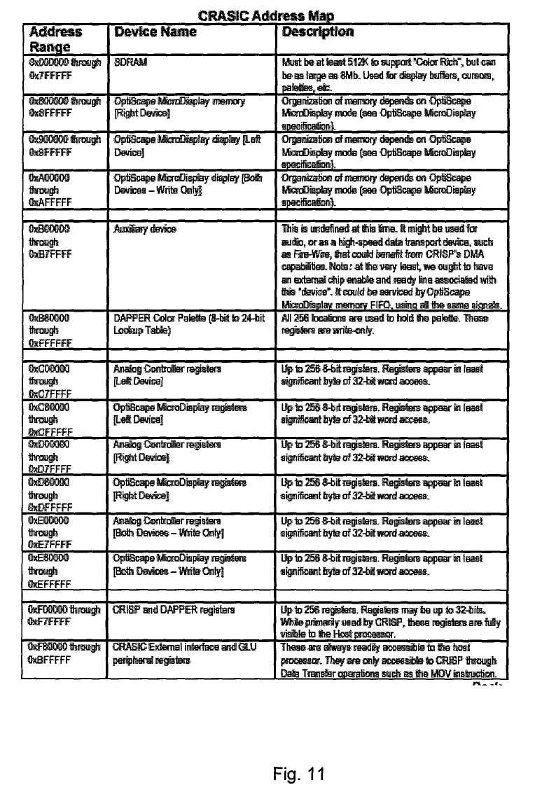

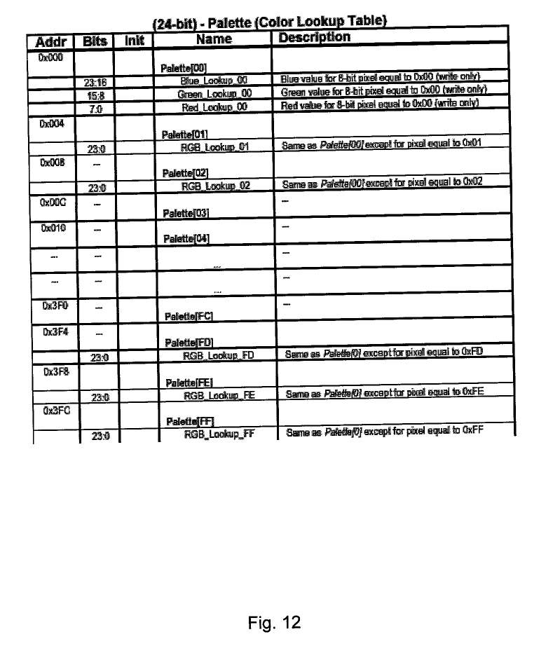

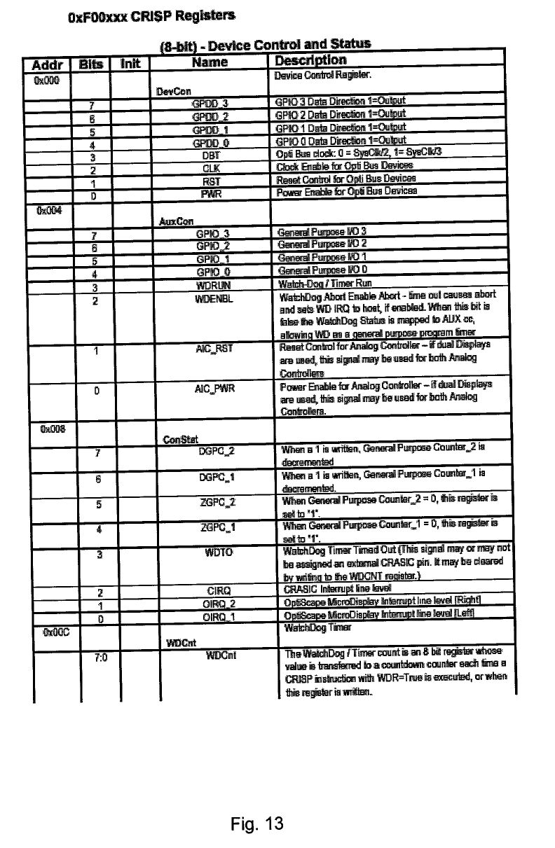

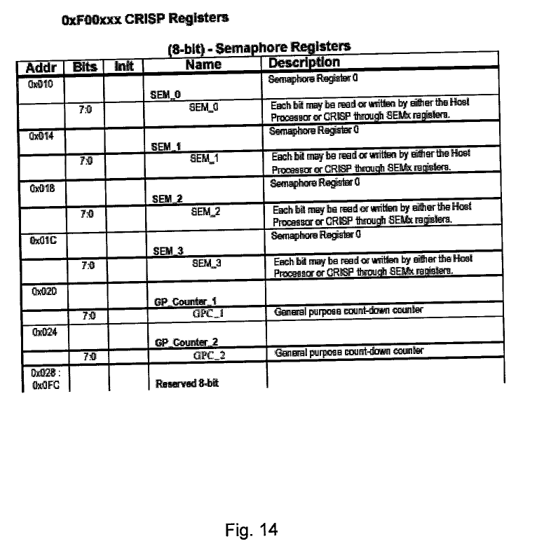

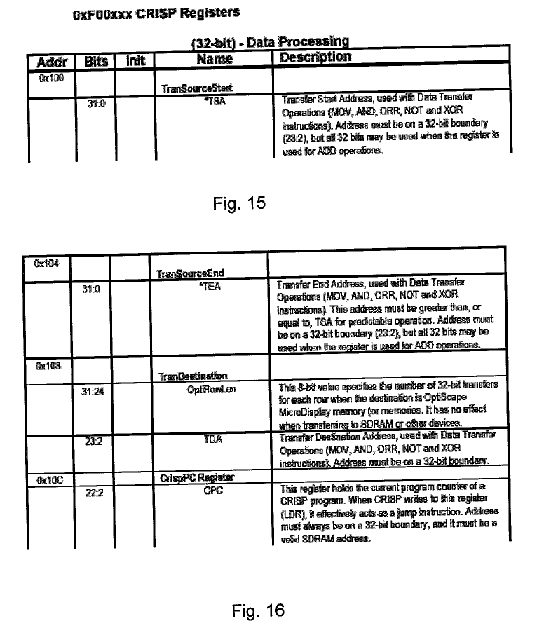

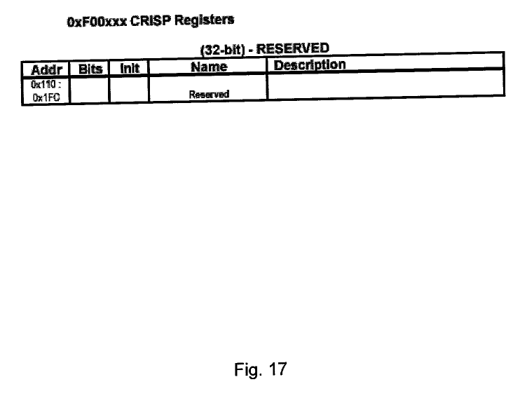

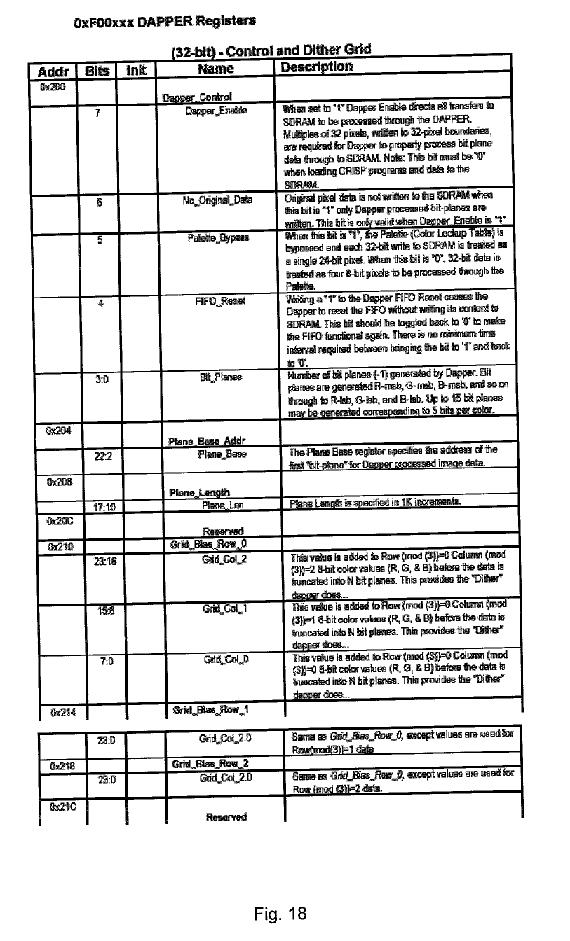

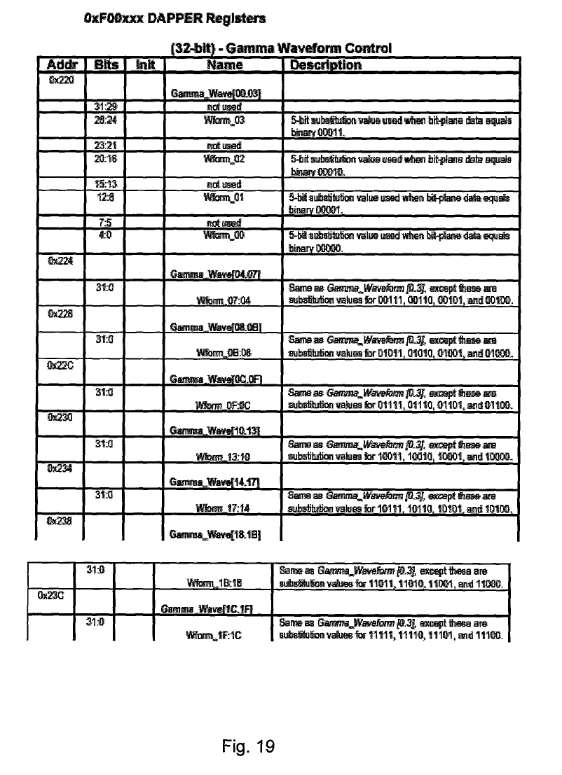

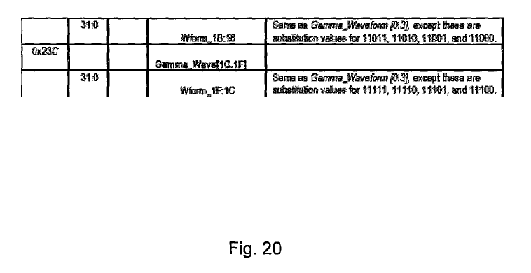

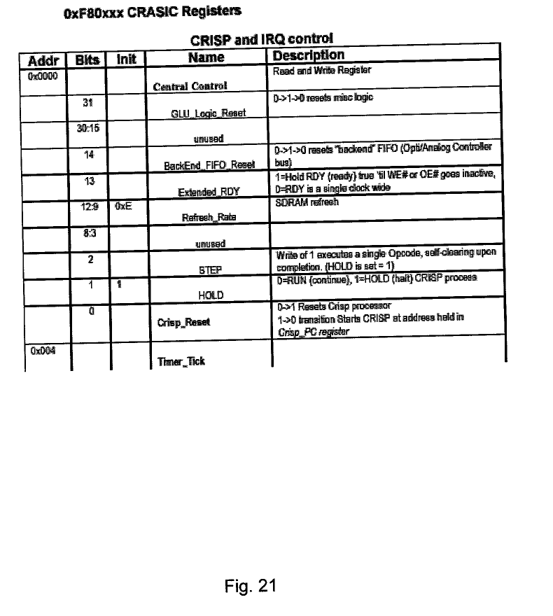

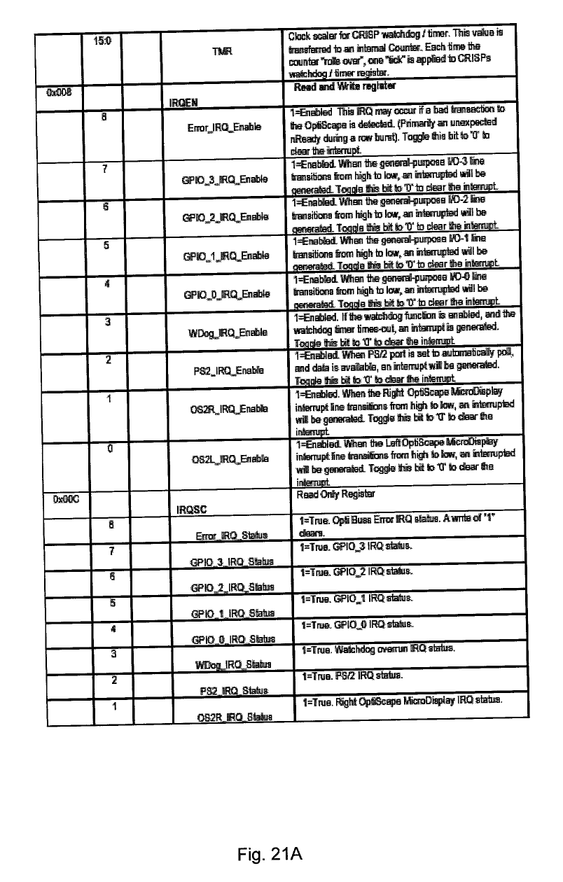

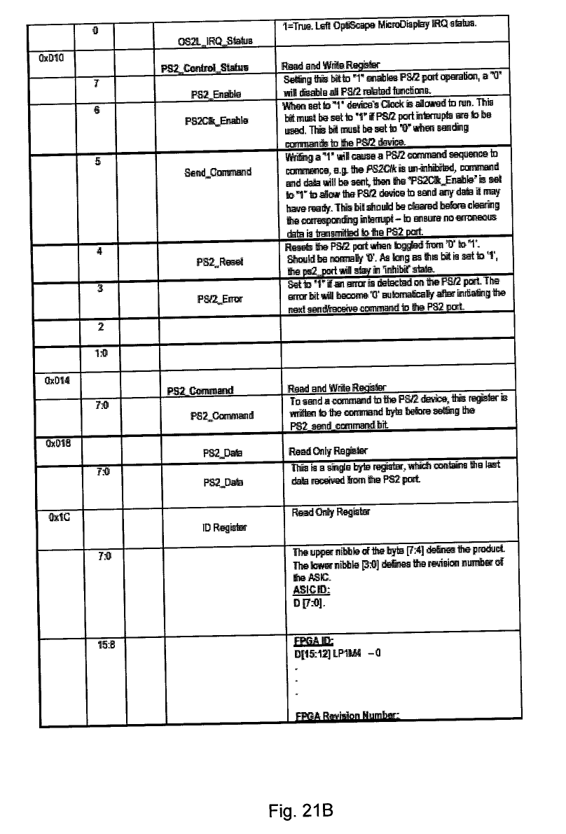

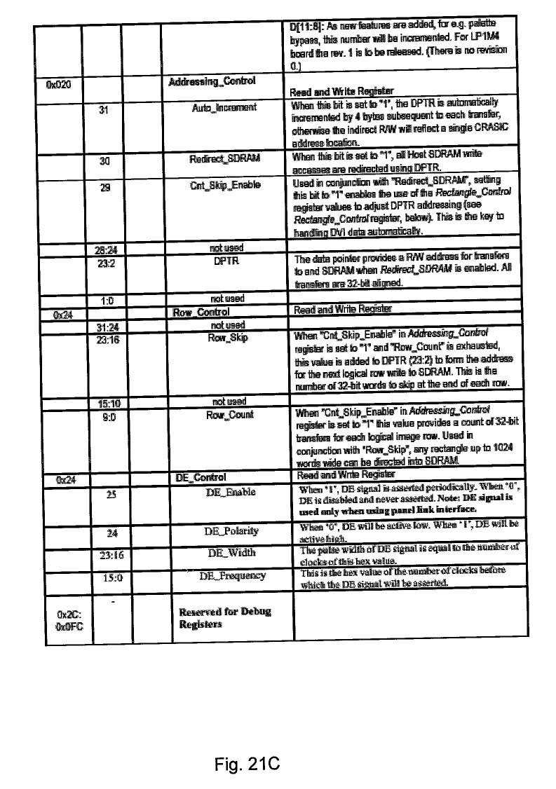

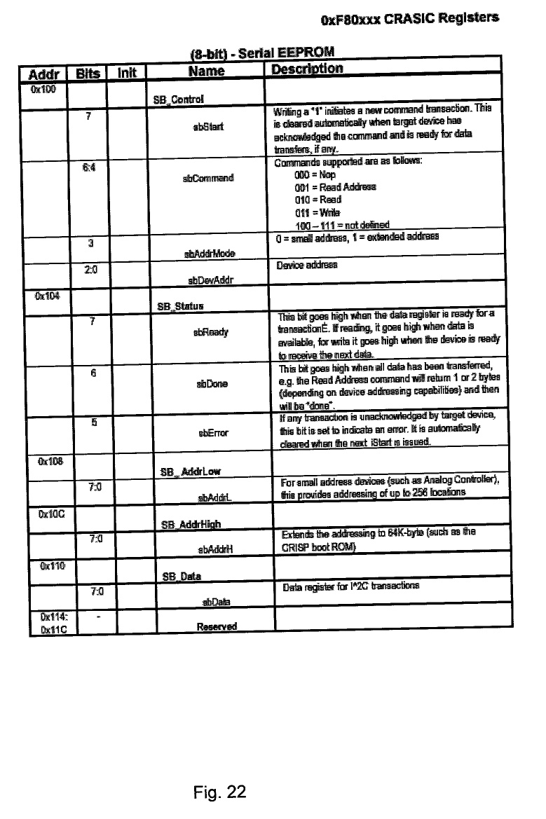

FIG. 11 illustrates an exemplary address map for the various components of the controller 100 of the present invention. FIGS. 12-22 illustrate register maps associated with the various components of the present invention. More operational details regarding the major components of the present invention will now be set forth.

Dapper (220)

The display module supports a native color depth of one bit per color, e.g. 8 possible colors for each pixel. In order to generate higher color depths, image data must be separated into color planes for each bit of color depth. Each image color plane is written to the display module once per frame, reproducing the image on the display. The color separation process is somewhat time consuming and inconvenient on most microprocessors. The DAPPER 220 relieves the microprocessor 102 from this chore by automatically separating the color planes as 24 bit image data is written to the display buffer. In addition, DAPPER 220 allows a more compact representation through the use of the 8-to-24-bit color palettes 216 and spatial dithering bias grid module 218.

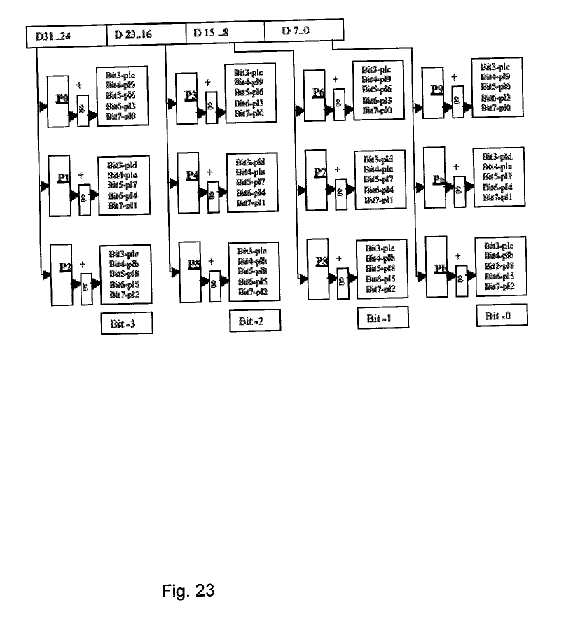

FIG. 23 illustrates how each byte of image data is processed through the palettes 216, adjusted by the dithering bias grid module 218, and separated into individual bit planes. Up to 5 bit planes per color can be generated automatically.

Dithering may be achieved with the use of a 3 by 3 noise injection grid. Each RGB color of pixel is rounded up or down according to the grid, producing on average the approximate original color when viewed over a group of adjacent pixels. Such spatial dithering improves color fidelity by 3 bits per color at the expense of absolute image resolution.

Either the microprocessor 102 or the controller 100 can initialize the three ‘grid’ (g) registers. Each register holds three “noise” values corresponding to pixel column modulo-3. The register used for a given row is selected by the value of row modulo-3.

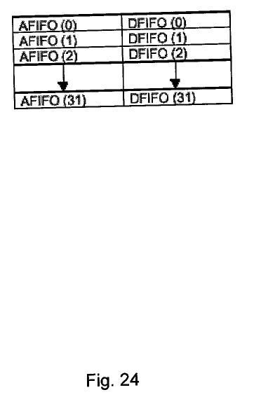

The 32 bit values of the unprocessed, and as well as the processed, data (Plane-registers) are written into the SDRAM 104. The address generated by the SDRAM arbitrator 226 is stored in an address FIFO (32 deep) known as AFIFO. See FIG. 24. The corresponding data is stored in a DFIFO. See FIG. 24. Table 3 illustrates the manner in which the SDRAM arbitrator 226 calculates the address for each plane register-write.

TABLE 3

Destination address = Plane_Base_Address + (A19-A3 of the
first write address remapped as A16-A0) + (Plane_number x
Plane_Length)

The Plane_number is the value referred by the row address A17-A14. The ‘Plane_Base_Address’ & ‘Plane_Length’ are registers initialized by either the microprocessor 102 or the CRISP 228. The data and addresses are written sequentially into the AFIFO and DFIFO as the bit plane FIFOs 222 are filled up. The address for the unprocessed data is retained as it is from the microprocessor 102. The address and the unprocessed data also are written into the AFIFO and DFIFO.

The SDRAM arbitrator 226 arbitrates for the local memory along with the CRISP 228 and the microprocessor 102. It only reads in the regular address space and not in the DAPPER address space. When it wins the arbitration, it writes the data into the corresponding address of the SDRAM 104.

FIG. 24 illustrates the AFIFO and the DFIFO, in accordance with one embodiment of the present invention. The AFIFO and DFIFO are designed into the system to reduce the latency, and unprocessed data writes of the microprocessor 104 into the DAPPER 220. If the AFIFO/DFIFO are full, and the CRISP 228 is moving data from the SDRAM 104 to the display module(s), the microprocessor 102 may be held off from completing a write operation for a predetermined amount of time.

Crisp (228)

The CRISP 228 is a very small instruction set processor used, primarily, to drive direct memory access (DMA) transfers from memory, i.e. SDRAM 104, to the display module(s). The CRISP 228 is the part of the controller 100 that programmatically controls the operation of the analog controller 106 and associated display module(s). The CRISP 228 is designed to handle a simple 512-Color mode of operation, but is flexible enough to manage higher color operations, as well as stereo imaging on dual displays. With its simple instruction set, it can simplify cursor tracking, fonts, and multiple screen and window management for the microprocessor 102.

In one embodiment, the CRISP 228 is capable being programmed to carry out specific low-level functions. By way of example, such low-level functions may include frame rate control, refreshing, field sequencing, DC balance management, illumination, and frame buffer control. It should be noted that such low-level functions are not limited to the above examples, and may include any function performed at the hardware-level.

It is thus possible to create a simplified (host) software interface to enable display module customers to develop products without having to understand the details of CRISP programming, the display module(s), or the analog controller 106. The CRISP programming may be auto-loaded from a serial EEPROM, or downloaded from the microprocessor 102 by a host driver at initialization.

To deliver a complete color rich solution for display module customers, it should simplify both hardware and software development. For the hardware, it can standardize the way color rich mode is implemented. For the software, it can eliminate the need for separating color planes, and provide automatic conversion from industry standard pixel definitions to that of a particular display module(s). Table 4 shows a list of functional desires and/or requirements.

TABLE 4

Support for varied color depth, allowing tradeoff between
color depth and power usage. Minimum of 512 colors
Conversion from 8, 16, and 24 bits per pixel to color rich.
Color palettes and real time dithering.
Support for two displays, simultaneously.
System must be capable of video frame-rate image throughput.
Low power consumption while display image is static.
Support for Fonts, Cursors, Windows, etc.
32-bit bus to maximize throughput.
Buffer memory addressing is flexible, avoiding hard coded
address maps.
An integrated “Watch-Dog” to protect the liquid crystal
display.

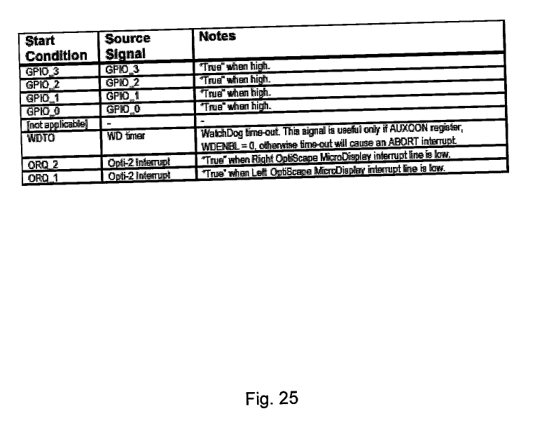

FIG. 25 is a chart illustrating the various start conditions associated with the instructions of the CRISP 228. The majority of CRISP instructions have a field called start conditions. This field specifies which signal(s) must be “true” before the instruction is allowed to execute. The instruction halts the CRISP 228 until the conditions are satisfied. Note that a Watchdog timer can prevent the processor from hanging indefinitely in the event that the specified signals never come “true”.

The start condition(s) to be tested are specified in the instruction as a “1” or “true”, while conditions to be ignored are “0”. Interrupt signals are “true” when they are “asserted” by the display module.

This capability allows for precise synchronization of display data transfers between buffer memory, and the display module(s). Registers for all devices may also require synchronous updates according to the state of the display module(s).

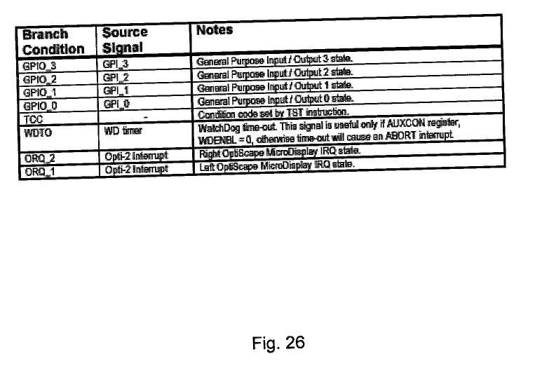

FIG. 26 illustrates a chart including CRISP branch conditions. The CRISP flow control instructions have branch conditions, instead of start conditions. Branch conditions are immediately tested, and the instruction executes according to the results of the test. Flow control instructions allow for more complex “real-time” programs, such as automatically updating a cursor's screen position or preparing new host data for display utilizing the time between display module field updates.

The branch condition(s) to be tested are specified in the instruction as a “1”, while conditions to be ignored are “0”. Unlike start conditions, branch conditions are tested as high or low, not true or false. The actual state of a tested flag or signal is important.

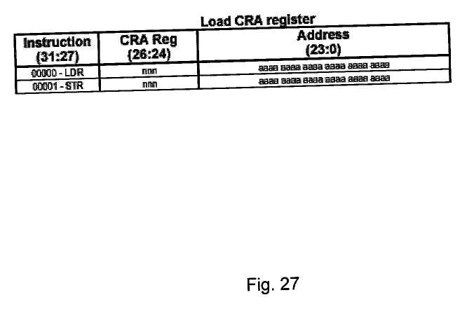

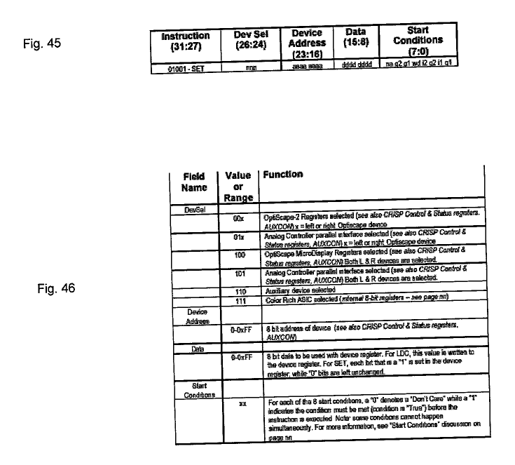

FIGS. 27-57 illustrate the various instructions that may be executed by the CRISP 228, in accordance with one embodiment of the present invention. FIG. 27 illustrates instructions that move the data found at the specified address to/from one of up to eight registers in the CRISP 228.

Data Transfer Operations

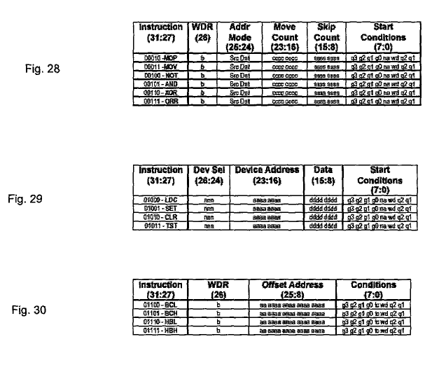

These instructions move data from one part of memory to another, or to memory mapped devices such as the display module(s). Some of the instructions combine source and destination data using Boolean operators. Note FIG. 28.

Immediate Data Operations

These instructions operate on 8-bit registers found on the display module(s), analog controller 106, CRISP 228, and any additional devices. Note FIG. 29.

Flow Control Operations

These instructions provide program flow control to create loops and conditional execution. Note FIG. 30.

Timing Control Operations

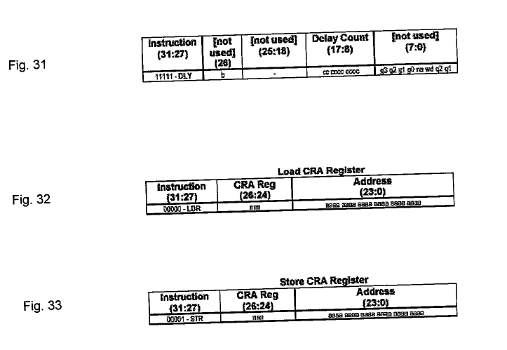

This instruction provides precise inline timing for display field control. Note FIG. 31. Note that instructions 10000 through 11110 are undefined and should not be used.

LDR reg, Address

Data found at the address location specified is loaded to specified register. Note FIG. 32. The details of this instruction's fields may be found in FIG. 34.

STR reg, Address

The contents of the specified register are written to memory at the specified address. Note FIG. 33. The current values designating CRA registers (nnn) are found in FIG. 34.

MOP wdr, smode=1, dmode=0, mCount, sCount, Conditions

MOP operates to move memory to display module. This instruction copies 32-bit words from “source address” memory through “end address”, to “destination address” of the display module(s). This instruction invokes an optimized data path between the SDRAM 104 and the display module(s). FIG. 35.

MOV wdr, smode, dmode, mCount, sCount, Conditions

This general purpose data move instruction copies 32-bit words from “source address” to “destination address” according to SRC and DST “Addr mode” settings. Note FIG. 36. FIG. 37 illustrates a breakdown of each of the fields for MOP and MOV

NOT wdr, smode, dmode, mCount, sCount, Conditions

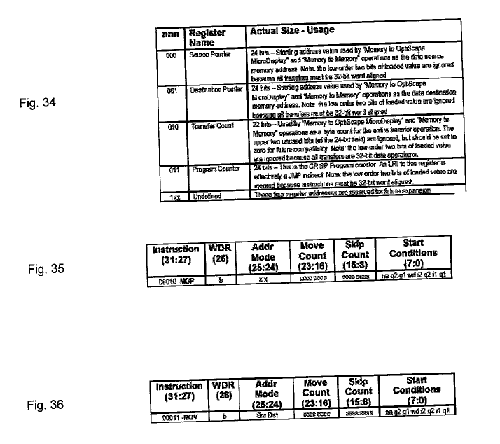

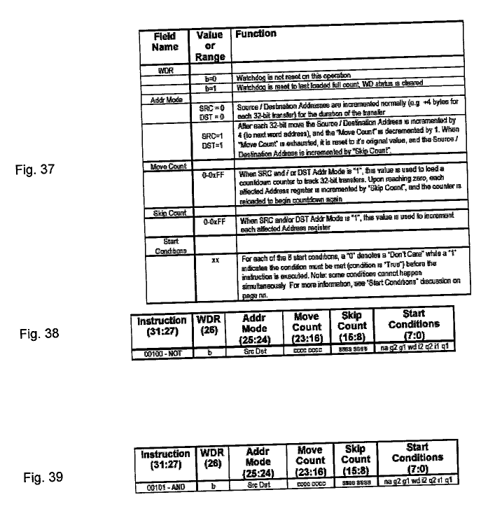

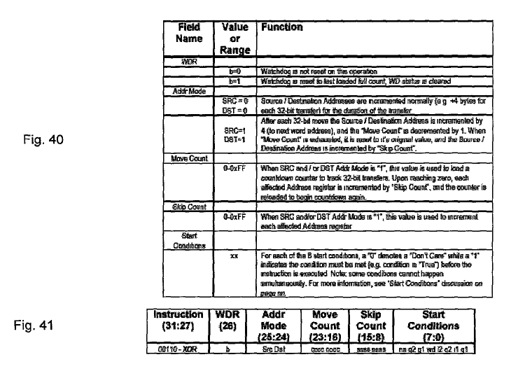

This instruction transfers 32 bit words from “source address” through “end address” to “destination address” according to SRC and DST “Addr Mode” settings. The destination data is inverted from the source data. Note FIG. 38. Details of this instruction's fields are found in FIG. 40.

AND wdr, smode, dmode, mCount, sCount, Conditions

This instruction transfers 32 bit words from “source address” through “end address” to “destination address” according to SRC and DST “Addr Mode” settings. The prior data at the destination address is ANDed with the source data, then stored at the destination address. Note FIG. 39. FIG. 40 illustrates a breakdown of each of the fields for NOT and AND.

XOR wdr, smode, dmode, mCount, sCount, Conditions

This instruction transfers 32 bit words from “source address” through “end Address” to “destination Address” according to SRC and DST “Addr Mode” settings. The prior data at the destination address is EXCLUSIVE-Ored with the source data, then stored at the destination address. Note FIG. 41. Details of this instruction's fields are found in FIG. 43.

ORR wdr, smode, dmode, mCount, sCount, Conditions

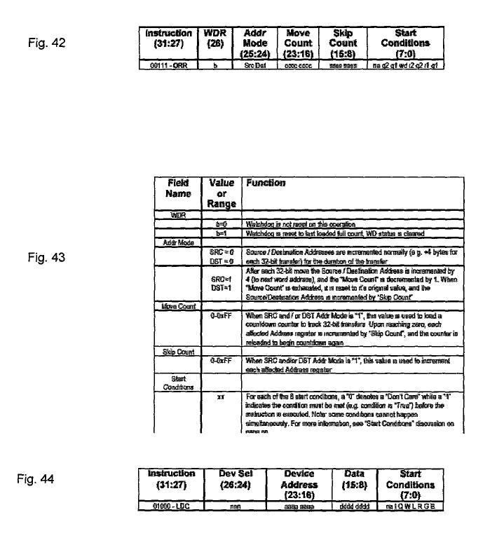

This instruction transfers 32 bit words from “source address” through “end address” to “destination address” according to SRC and DST “Addr mode” settings. The prior data at the destination address is ORed with the source data, then stored at the destination address. Note FIG. 42. FIG. 43 illustrates a breakdown of each of the fields for XOR and ORR.

LDC dSel, dAddr, data, Conditions

This instruction writes the immediate data to the specified device register address (regAddr). Note FIG. 44. Details of this instruction's fields are found in FIG. 46.

SET dSel, dAddr, data, Condition

This instruction ORs the immediate data with the specified device register address (regAddr), then writes the result to that same device register address. Note FIG. 44. FIG. 46 illustrates a breakdown of each of the fields for LDC and SET.

CLR dSel, daddr, data, Condition

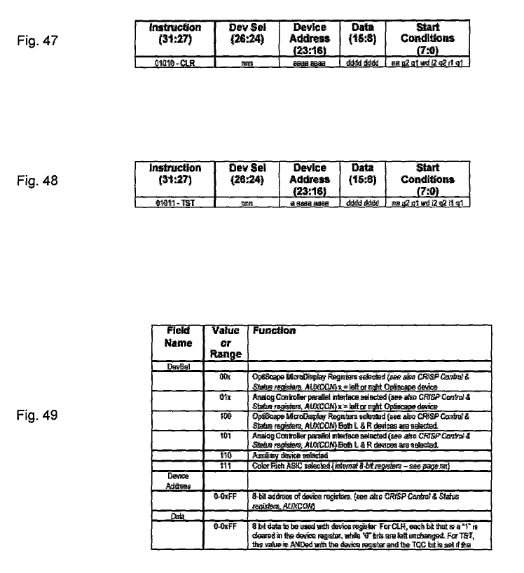

This instruction inverts the immediate data; ANDs the result with the specified device register address (regAddr), then writes the result to that same device register address. Note FIG. 47. Details of this instruction's fields are found in FIGS. 49 and 49A.

TST dSel, dAddr, data, Conditions

This instruction ANDs the immediate Data with specified device register. When the results are 0×00, the “TCC” bit of the condition register is cleared (false). Otherwise it is set (true). The specified device register is unchanged by this operation. Note FIG. 48. FIGS. 49 and 49A illustrate a breakdown of each of the fields for CLR and TST.

BCL (Branch if Condition LOW)

The selected conditions are tested immediately against the source signals to determine if the branch is to be taken or not. If all conditions are not met, the branch is taken. Non-selected conditions are ignored; thus a BCL with no conditions would always branch. If the selected conditions are met, the instruction processing continues at the next subsequent instruction. Note FIG. 50.

BCH (Branch if Condition HIGH)

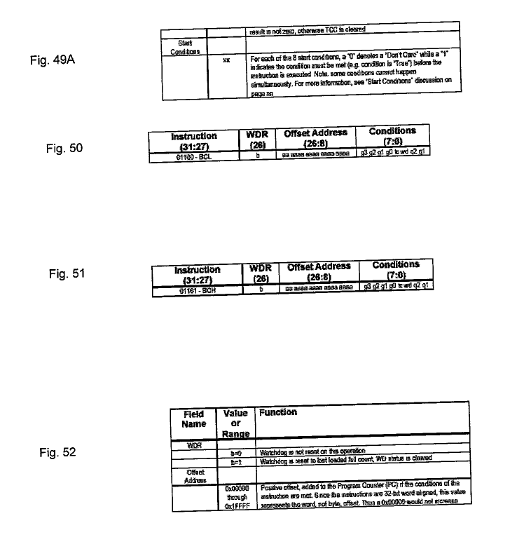

The selected conditions are tested immediately against the source signals to determine if the branch is to be taken or not. If all conditions are met, the branch is taken. Non-selected conditions are ignored; thus a BCH with no conditions would always branch. If the selected conditions are not met, the instruction processing continues at the next subsequent instruction. Note FIG. 51. FIGS. 52 and 52A illustrate a description for each of the fields of BCH and BCL.

HBL (Halt if Condition LOW)

The selected conditions are tested immediately against the source signals to determine if the branch is to be taken or not. If all conditions are not met, the instruction processing is halted. Non-selected conditions are ignored; thus a HBL with no conditions would halt instruction processing. If the selected conditions are met, the instruction processing continues at the offset address. Note FIG. 53.

HBT (Halt if Condition HIGH)

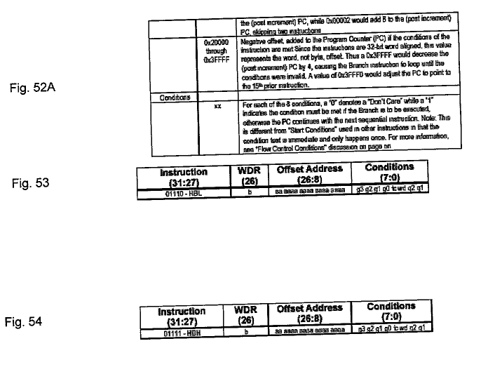

The selected conditions are tested immediately against the source signals to determine if the branch is to be taken, or not. If all conditions are met, the instruction processing is halted. Non-selected conditions are ignored; thus a HBH with no conditions would halt instruction processing. If the selected conditions are not met, the instruction processing continues at the offset address. Note FIG. 54. FIG. 55 shows a description for each of the fields of HBH and HBL.

Delay

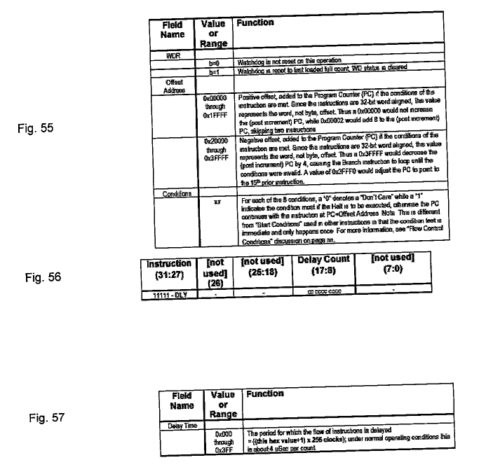

The delay instruction is used when the CRISP 228, rather than the built-in timing parameters of the display module(s) are controlling all display timing. Note FIG. 56. FIG. 57 is a description for each of the fields of DLY.

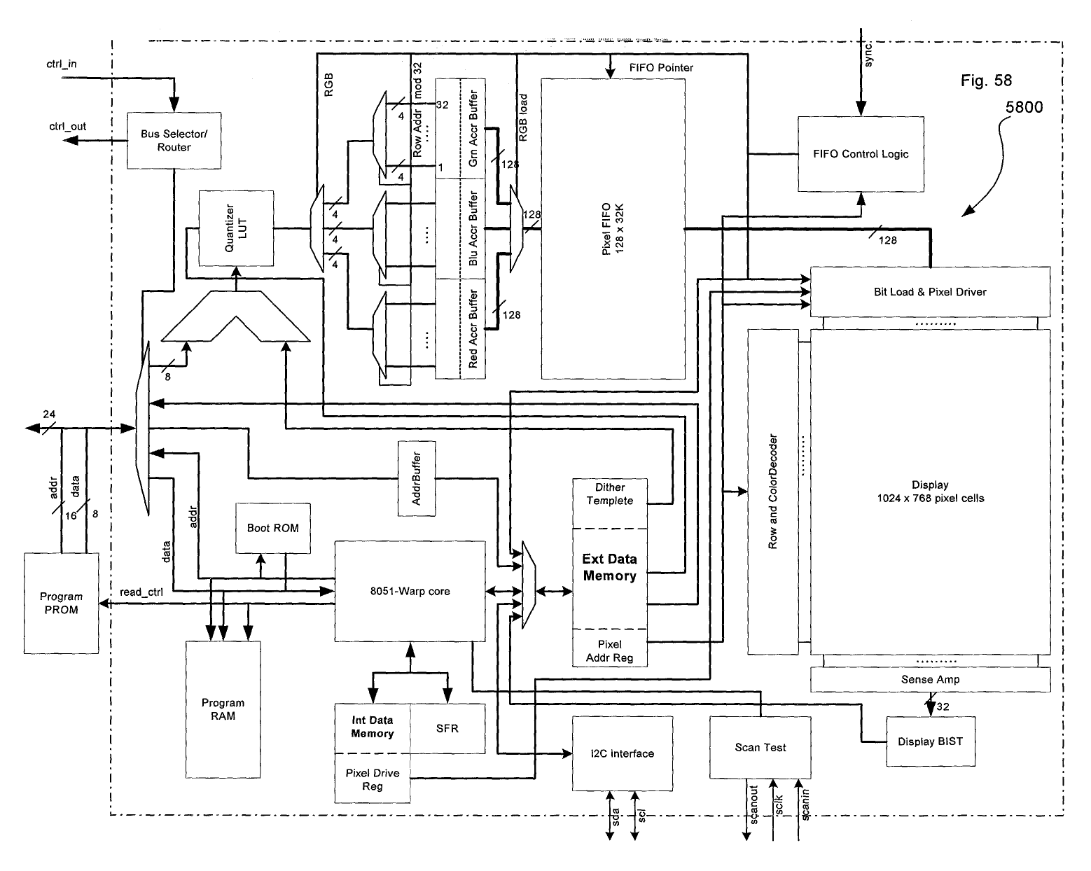

FIG. 58 illustrates an exemplary architecture 5800 associated with the display modules shown in FIGS. 1 and 2. It should be noted that such display architecture may vary per the desires of the user, and may further be accommodated by the programmable nature of the present invention.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for controlling operation of a display, comprising:
(a) programming a processor of a display controller;
(b) driving at least one display module with the display controller in accordance with the programming in step (a), the driving including the control of low-level functions associated with the display; and
(c) wherein the processor of the display controller is capable of being programmed to drive the at least one display module in a plurality of drive modes.

2. The method as recited in claim 1, wherein the at least one display module includes a microdisplay.

3. The method as recited in claim 1, wherein at least two display modules are driven by the display controller.

4. The method as recited in claim 1, wherein the processor of the display controller is programmed utilizing electronically erasable programmable read only memory (EEPROM) coupled thereto.

5. The method as recited in claim 1, wherein the processor of the display controller is programmed by an external processor coupled thereto.

6. The method as recited in claim 1, wherein the processor of the display controller is programmed utilizing a predetermined instruction set.

7. The method as recited in claim 1, wherein the processor of the display controller functions as a direct memory access (DMA) controller.

8. The method as recited in claim 7, wherein the processor of the display controller transfers data from a frame buffer to a backplane.

9. The method as recited in claim 7, wherein the memory accessed includes a synchronous dynamic random access memory (SDRAM).

10. The method as recited in claim 1, wherein the display controller further includes a dithering and planarization processing engine and router (DAPPER).

11. The method as recited in claim 1, wherein the low-level functions are selected from the group consisting of frame rate control, refreshing, field sequencing, DC balance management, illumination, external signaling, and frame buffer control.

12. The method as recited in claim 1, wherein the low-level functions include frame rate control, refreshing, field sequencing, DC balance management, illumination, external signaling, and frame buffer control.

13. A programmable display controller, comprising:
(a) an input for receiving image data from a data source;
(b) a processor coupled to the input, the processor adapted for being programmed to process the received data in accordance with user-specified instructions; and
(c) an output coupled to the processor for sending the processed data to at least one display module for driving the at least one display module in accordance with the user-specified instructions; (d) wherein the driving includes the control of low-level functions associated with the display.

14. The display controller as recited in claim 13, wherein the at least one display module includes a microdisplay.

15. The display controller as recited in claim 13, wherein at least two display modules are driven by the display controller.

16. The display controller as recited in claim 13, wherein the processor of the display controller is programmed utilizing electronically erasable programmable read only memory (EEPROM) coupled thereto.

17. The display controller as recited in claim 13, wherein the processor of the display controller is programmed by an external processor coupled thereto.

18. The display controller as recited in claim 13, wherein the processor of the display controller is programmed utilizing a predetermined instruction set.

19. The display controller as recited in claim 13, wherein the processor of the display controller functions as a direct memory access (DMA) controller.

20. The display controller as recited in claim 19, wherein the processor of the display controller transfers data from a frame buffer to a backplane.

21. The display controller as recited in claim 19, wherein the memory accessed includes a synchronous dynamic random access memory (SDRAM).

22. The display controller as recited in claim 13, wherein the display controller further includes a dithering and planarization processing engine and router (DAPPER).

23. The display controller as recited in claim 13, wherein the data is processed by reformatting the same to accommodate a particular display device.

24. The display controller as recited in claim 13, wherein the low-level functions are selected from the group consisting of frame rate control, refreshing, field sequencing, DC balance management, illumination, external signaling, and frame buffer control.

25. The display controller as recited in claim 13, wherein the low-level functions include frame rate control, refreshing, field sequencing, DC balance management, illumination, external signaling, and frame buffer control.

26. A computer program product for programming a display controller, comprising:
(a) computer code for programming a processor of a display controller;
(b) wherein the processor of the display controller is capable of driving at least one display module with the display controller in accordance with the programming, the driving including the control of low-level functions associated with the display.
